(19) United States
(12) Patent Application Publication
(10) Pub. No.: US 2022/0004065 A1
(43) Pub. Date: Jan. 6, 2022

(54) EMBEDDED TOUCH LIQUID CRYSTAL DISPLAY

(71) Applicant: WUHAN CHINA STAR OPTOELECTRONICS TECHNOLOGY CO., LTD., Wuhan, Hubei (CN)

(72) Inventors: Yuejun TANG, Wuhan, Hubei (CN); Xueyun LI, Wuhan, Hubei (CN)

(21) Appl. No.: 16/626,576

(22) PCT Filed: Jun. 20, 2019
(86) PCT No.: PCT/CN2019/092096

§ 371 Date: Aug. 10, 2021

(30) Foreign Application Priority Data
Feb. 20, 2019 (CN) 201910127533.9

(51) Int. Cl. G02F 1/1362; G02F 1/1368

(52) U.S. Cl. CPC G02F 1/136222; G02F 1/1368; G02F 1/136286; G02F 1/136209

(57) ABSTRACT

The present invention provides an embedded touch liquid crystal display, including: a color filter (CF) substrate including a plurality of first filters, a plurality of second filters, and a plurality of third filters sequentially arranged in a first cycle, wherein the first cycle is equal to a number of colors of the filters; a transistor (TFT) substrate, disposed under the color filter substrate, and including: a plurality of touch wires and a plurality of data lines, which are disposed in parallel with each other in a same layer, wherein each of the plurality of touch wires is disposed between adjacent two of the plurality of data lines in a second cycle different from the first cycle, wherein the plurality of first filters, the plurality of second filters, and the plurality of third filters respectively correspond to a plurality of first sub-pixels.

### BACKGROUND OF INVENTION

### Field of Invention

The present invention relates to an embedded touch liquid crystal display, and more particularly to an embedded touch liquid crystal display for improving color shift at large viewing angles.

### Description of Prior Art

Liquid crystal displays have been widely used in people's daily lives and production activities. With an advancement of electronic technology and a fierce competition in display industry, liquid crystal displays are gradually optimizing and improving in terms of optical taste.

FIG. 1 is a schematic diagram showing an arrangement of sub-pixels 30, data lines 20, and touch wires 10 of a conventional liquid crystal display 100. As shown in FIG. 1, in the embedded touch fringe field switch (FFS) liquid crystal display 100, a common electrode (not shown) is divided into a plurality of block touch sensing electrodes by an array, that is, the common electrode is also used as a touch sensing electrode (not shown). Each of the touch sensing electrodes (not shown) is electrically connected to at least one of the touch wires 10, and the touch wire 10 is time-sharing driven to provide a common voltage signal and a touch signal to the touch sensing electrode (not shown). In the embedded touch FFS liquid crystal display 100, the touch wires 10 and the data lines 20 are arranged in parallel with each other in a same layer, wherein the data lines 20 and the touch wires 10 are made of the same material and manufactured in a same process. FIG. 2 is a side view showing an arrangement of the black matrices 40, the sub-pixels 30, the data lines 20, and the touch wires 10 of the conventional liquid crystal display 100. Referring to FIG. 1 and FIG. 2, in the embedded touch FFS liquid crystal display 100 shown in FIG. 1 and FIG. 2, the touch wires 10 are located between the green sub-pixels G, the blue sub-pixels B, and the green sub-pixels. A width of each of the black matrices 40a above the touch wires 10 and the data lines 20 between the green sub-pixels G and the blue sub-pixels B is greater than a width of each of the black matrices 40a between the red sub-pixels R and the green sub-pixels G and between the blue sub-pixels B and the red sub-pixels R. When the embedded touch FFS liquid crystal display 100 is viewed in a large viewing angle, the wider black matrices 40a corresponding to a region between the green sub-pixels G and the blue sub-pixels B can mask more lights, and specifically reduce light leakage at large viewing angles from right perspective of the green solid color screen and from left perspective of the blue solid color screen, thereby reducing the color shift at large viewing angles from right perspective of the green solid color screen and left perspective of the blue solid color screen, improving the optical taste at large viewing angles. However, in the cases of viewing other solid color screens (such as the red solid color screen) or viewing in a large viewing angles in other directions, there is more light leakage at large viewing angles, resulting in a larger color shift, thus lowering the optical taste.

### SUMMARY OF INVENTION

In view of this, the present invention provides an embedded touch liquid crystal display, including: a color filter (CF) substrate including a plurality of filters and a plurality of black matrices between the plurality of filters arranged in a same layer, wherein the plurality of filters includes in least: a plurality of first filters, a plurality of second filters, and a plurality of third filters, which have colors different from each other, and are sequentially arranged in a first cycle, wherein the first cycle is equal to a number of colors of the filters of the color filter substrate; a transistor (TFT) substrate, disposed under the color filter substrate, and including: a plurality of touch wires and a plurality of data lines, which are disposed in parallel with each other in a same layer, wherein each of the plurality of touch wires is disposed between adjacent two of the plurality of data lines in a second cycle different from the first cycle, wherein the plurality of first filters, the plurality of second filters, and the plurality of third filters respectively correspond to a plurality of first sub-pixels, a plurality of second sub-pixels, a plurality of third sub-pixels, which have colors different from each other, and are sequentially arranged in the first cycle.

According to an embodiment of the invention, the plurality of black matrices include a plurality of first black matrices and a plurality of second black matrices, wherein the plurality of first black matrices correspond to the plurality of touch wires and the data lines adjacent to the plurality of touch wires, the plurality of second black matrices correspond to remaining data lines, and a width of each of the first black matrices is greater than a width of each of the second black matrices.

According to an embodiment of the invention, a sum of areas of the plurality of first sub-pixels masked by the corresponding black matrices, a sum of areas of the plurality of second sub-pixels masked by the corresponding black matrices, and a sum of areas of the plurality of third sub-pixels masked by the corresponding black matrices are same.

According to an embodiment of the invention, the first cycle is 3, and the plurality of first filters, the plurality of second filters, and the plurality of third filters are red (R), green (G), and blue (B) respectively. In this embodiment, the second cycle is not a multiple of 3, Instead, the second cycle is a multiple of 2 or a multiple of 5.

According to an embodiment of the invention, the embedded touch liquid crystal display further includes: a plurality of fourth filters corresponding to a plurality of fourth sub-pixels, wherein the first cycle is 4, and the plurality of first filters, the plurality of second filters, the plurality of third filters, and the plurality of fourth filters are red (R), green (G), blue (B), and white (W), while the second cycle is not a multiple of 4.

According to an embodiment of the invention, the embedded touch liquid crystal display further includes: a liquid crystal layer disposed between the color filter substrate and the transistor substrate; an upper polarizer disposed on the color filter (CF) substrate; and a lower polarizer disposed under the transistor (TFT) substrate.

According to an embodiment of the invention, the embedded touch liquid crystal display is an embedded touch fringe field switch (FFS) liquid crystal display.

The present invention provides an embedded touch liquid crystal display for improving a color shift in a large-viewing angle, which adopts designs that the data lines and the touch wires are arranged in parallel with each other in a same layer, and the touch wires and/or dummy touch wires are spaced apart in a certain cycle which is a non-integer multiple of a number of colors of the sub-pixels, such that all of the sub-pixels are uniformly masked by the data lines and the touch wires arranged in parallel with each other in a same layer, the touch wires and/or the dummy touch wires, and the black matrices on its opposite side. As such, when a consumer views the embedded touch liquid crystal display of the present invention at a large viewing angle, color shift at a large viewing angle of a screen is improved irrespective of the solid colors being displayed by sub-pixels, thereby obtaining a better display taste.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic diagram showing an arrangement of sub-pixels, data lines, and touch wires of a conventional liquid crystal display.

FIG. 2 is a side view showing the arrangement of the sub-pixels, the data lines, and the touch wires of the liquid crystal display of FIG. 1.

FIG. 3 is a schematic diagram showing an arrangement of sub-pixels, data lines, and touch wires of an embedded touch liquid crystal display according to an embodiment of the invention.

FIG. 4 is a side view showing the arrangement of the sub-pixels, the data lines, and the touch wires of the liquid crystal display of FIG. 3.

FIG. 5 is a schematic diagram showing an arrangement of sub-pixels, data lines, and touch wires of an embedded touch liquid crystal display according to another embodiment of the invention.

FIG. 6 is a side view showing the arrangement of the sub-pixels, the data lines, and the touch wires of the liquid crystal display of FIG. 5.

FIG. 7 is a schematic diagram showing an arrangement of sub-pixels, data lines, and touch wires of an embedded touch liquid crystal display according to yet another embodiment of the invention.

FIG. 8 is a side view showing the arrangement of the sub-pixels, the data lines, and the touch wires of the liquid crystal display of FIG. 7.

FIG. 9 is a schematic diagram showing an arrangement of sub-pixels, data lines, and touch wires of an embedded touch liquid crystal display according to still another embodiment of the invention.

FIG. 10 is a side view showing the arrangement of the sub-pixels, the data lines, and the touch wires of the liquid crystal display of FIG. 9.

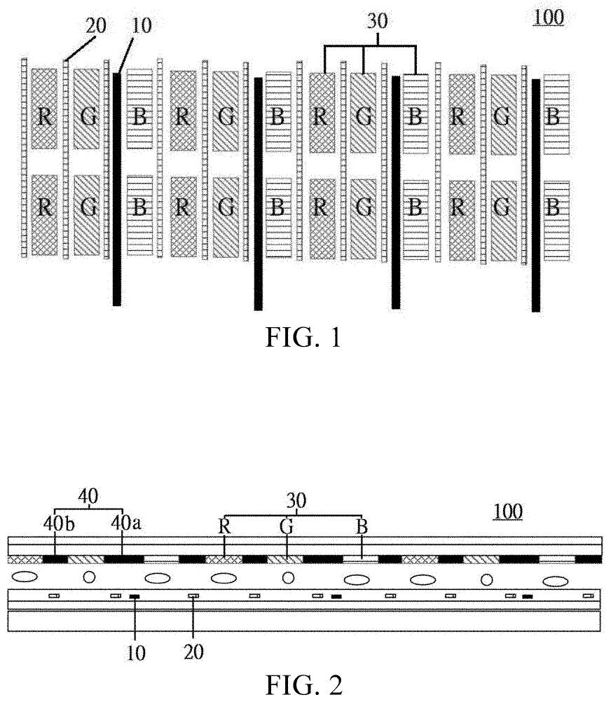

### DETAILED DESCRIPTION OF PREFERRED EMBODIMENTS

In order to make the above description of the present invention more comprehensible, the preferred embodiments are described below in detail with reference to the accompanying drawings.

The following description of the various embodiments is provided to illustrate the specific embodiments of the invention. Directional terms mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology used is for the purpose of illustration and understanding of the invention. In the figures, structurally similar elements are denoted by the same reference numerals.

The terms “first”, “second”, and “third”, etc., are used to describe various components, elements, regions, layers, and/or blocks. However, these components, elements, regions, layers, and/or blocks should not be limited by these terms. These terms are limited to identify a single component, element, region, layer, and/or block. Therefore, a first component, component, region, layer, and/or block may also be referred to as a second component, element, region, layer, and/or block, without departing from the scope of the invention. As used herein, the term “and/or” encompasses any combination of one or more of the listed associated items. The term “and/or” as used in this document refers to any combination of any one, all, or at least one of the listed components.

The present invention provides an embedded touch liquid crystal display for improving color shift at large-viewing angles, which adopts designs that the data lines and the touch wires are arranged in parallel with each other in a same layer, and the touch wires and/or dummy touch wires are spaced apart in a certain cycle which is a non-integer multiple of a number of colors of the sub-pixels, such that all of the sub-pixels are uniformly masked by the data lines and the touch wires arranged in parallel with each other in a same layer, the touch wires and/or the dummy touch wires, and the black matrices on its opposite side. As such, when a consumer views the embedded touch liquid crystal display of the present invention at a large viewing angle, color shift at a large viewing angle of a screen is improved irrespective of the solid colors being displayed by sub-pixels, thereby obtaining a better display taste.

According to an embodiment of the invention, the embedded touch liquid crystal display is an embedded touch fringe field switch (FFS) liquid crystal display.

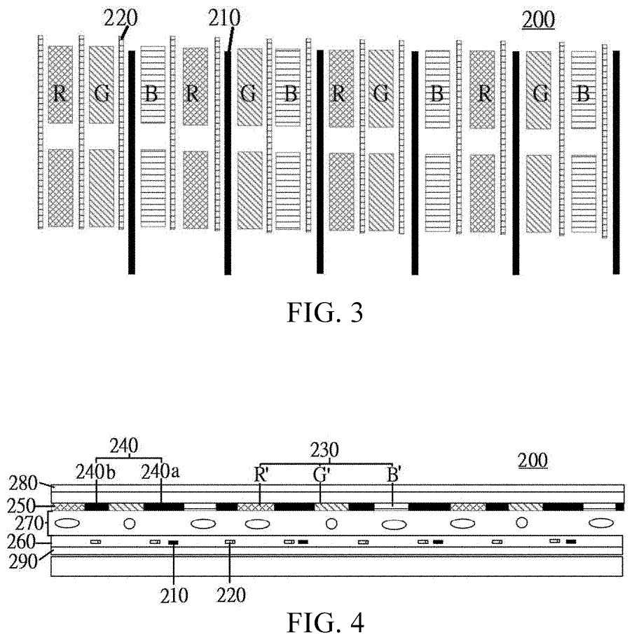

FIG. 3 is a schematic diagram showing an arrangement of sub-pixels, data lines, and touch wires of an embedded touch liquid crystal display according to an embodiment of the invention. FIG. 4 is a side view showing the arrangement of the sub-pixels, the data lines, and the touch wires of the liquid crystal display of FIG. 3. Referring to FIG. 3 and FIG. 4, the present invention provides an embedded touch liquid crystal display 200, including: a color filter (CF) substrate 250 including a plurality of filters 230 and a plurality of black matrices 240 between the plurality of filters 230 arranged in a same layer, wherein the plurality of filters 230 includes at least: a plurality of first filters R′, a plurality of second filters G′, and a plurality of third filters B′, which have colors different from each other, and are sequentially arranged in a first cycle, wherein the first cycle is equal to a number of colors of the filters of the color filter substrate; and a transistor (TFT) substrate 260, disposed under the color filter substrate 250, and including: a plurality of touch wires 210 and a plurality of data lines 220, which are disposed in parallel with each other in a same layer, wherein each of the plurality of touch wires 210 is disposed between adjacent two of the plurality of data lines 220 in a second cycle different from the first cycle.

In the embedded touch liquid crystal display 200 shown in FIG. 3 and FIG. 4, the plurality of first filters R′, the plurality of second filters G′, and the plurality of third filters B′ respectively correspond to a plurality of first sub-pixels R, a plurality of second sub-pixels G, and a plurality of third sub-pixels B, which have colors different from each other, and are sequentially arranged in the first cycle.

Still referring to FIG. 3 and FIG. 4, in the this embodiment, the plurality of black matrices 240 include a plurality of first black matrices 240a and a plurality of second black matrices 240b, wherein the plurality of first black matrices 240a correspond to the plurality of touch wires 210 and the data lines 220 adjacent to the plurality of touch wires 210, the plurality of second black matrices 240b correspond to the remaining data lines 220, and a width of each of the first black matrices 240a is greater than a width of each of the second black matrices 240b.

In this embodiment, the first cycle is 3, and the plurality of first filters R′, the plurality of second filters G′, and the plurality of third filters B′ are red (R), green (G), and blue (B) respectively. In this embodiment, the second cycle is 2, that is, one touch wire 210 is spaced apart by two data lines 220.

In this embodiment of the present invention, the data lines 220 and the touch wires 210 are arranged in parallel with each other in a same layer, and the touch wires 210 are spaced apart in a certain cycle which is a non-integer multiple of a number of colors of the sub-pixels. By the above arrangement, the plurality of first sub-pixels R, the plurality of second sub-pixels G, and the plurality of third sub-pixels B are uniformly masked by the data lines 220 and the touch wires 210 arranged in parallel with each other in a same layer, and by the corresponding black matrices 240. More specifically, referring to FIG. 3 and FIG. 4, in the above embodiment, a sum of areas of the plurality of first sub-pixels R masked by the corresponding black matrices 240, a sum of areas of the plurality of second sub-pixels G masked by the corresponding black matrices 240, and a sum of areas of the plurality of third sub-pixels B masked by the corresponding black matrices 240 are same. As such, the touch wires 210 are located between G and B, between R and G, between B and R, between G and B, between R and G, or between B and R, that is, in every six sub-pixels, one touch wire 210 is located between G and B, between R and G, or between B and R, and each of the black matrices above the touch wires has a relatively wider width, which can uniformly reduce the light leakage of the R/G/B solid color screens at large viewing angles, thereby improving the color shift at large viewing angles from right perspective and/or left perspective of the R/G/B solid color screens.

According to an embodiment of the invention, the embedded touch liquid crystal display may further include: a liquid crystal layer 270 disposed between the color filter substrate 250 and the transistor substrate 260; an upper polarizer 280 disposed on the color filter (CF) substrate 250; and a lower polarizer 290 is disposed under the transistor (TFT) substrate 260.

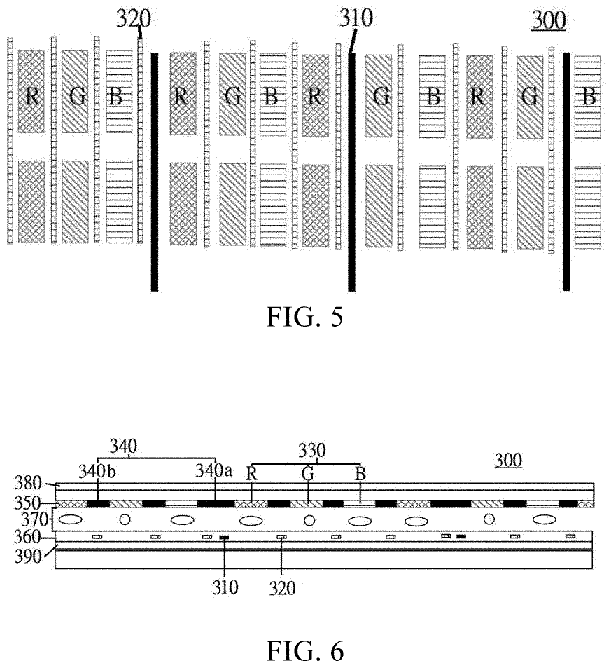

FIG. 5 is a schematic diagram showing an arrangement of sub-pixels, data lines, and touch wires of an embedded touch liquid crystal display according to an embodiment of the invention. FIG. 6 is a side view showing the arrangement of the sub-pixels, the data lines, and the touch wires of the liquid crystal display of FIG. 5. Referring to FIG. 5 and FIG. 6, the present invention provides an embedded touch liquid crystal display 300, including: a color filter (CF) substrate 350 including a plurality of filters 330 and a plurality of black matrices 340 between the plurality of filters 330 arranged in a same layer, wherein the plurality of filters 330 includes at least: a plurality of first filters R′, a plurality of second filters G′, and a plurality of third filters B′, which have colors different from each other, and are sequentially arranged in a first cycle, wherein the first cycle is equal to a number of colors of the filters of the color filter substrate; and a transistor (TFT) substrate 360, disposed under the color filter substrate 350, and including: a plurality of touch wires 310 and a plurality of data lines 320, which are disposed in parallel with each other in a same layer, wherein each of the plurality of touch wires 310 is disposed between adjacent two of the plurality of data lines 320 in a second cycle different from the first cycle.

In the embedded touch liquid crystal display 200 shown in FIG. 5 and FIG. 6, the plurality of first filters R′, the plurality of second filters G′, and the plurality of third filters B′ respectively correspond to a plurality of first sub-pixels R, a plurality of second sub-pixels G, and a plurality of third sub-pixels B, which have colors different from each other, and are sequentially arranged in the first cycle.

Still referring to FIG. 5 and FIG. 6, in the this embodiment, the plurality of black matrices 340 include a plurality of first black matrices 340a and a plurality of second black matrices 340b, wherein the plurality of first black matrices 340a correspond to the plurality of touch wires 310 and the data lines 320 adjacent to the plurality of touch wires 310, the plurality of second black matrices 340b correspond to remaining data lines 320, and a width of each of the first black matrices 340a is greater than a width of each of the second black matrices 340b.

In this embodiment, the first cycle is 3, and the plurality of first filters R′, the plurality of second filters G′, and the plurality of third filters B′ are red (R), green (G), and blue (B) respectively. In this embodiment, the second cycle is 4, that is, one touch wire 310 is spaced apart by four data lines 320.

In this embodiment of the present invention, the data lines 320 and the touch wires 310 are arranged in parallel with each other in a same layer, and the touch wires 310 are spaced apart in a certain cycle which is a non-integer multiple of a number of colors of the sub-pixels. By the above arrangement, the plurality of first sub-pixels R, the plurality of second sub-pixels G, and the plurality of third sub-pixels B are uniformly masked by the data lines 320 and the touch wires 310 arranged in parallel with each other in a same layer, and by the corresponding black matrices 340. More specifically, referring to FIG. 5 and FIG. 6, in the above embodiment, a sum of areas of the plurality of first sub-pixels R masked by the corresponding black matrices 340, a sum of areas of the plurality of second sub-pixels G masked by the corresponding black matrices 340, and a sum of areas of the plurality of third sub-pixels B masked by the corresponding black matrices 340 are same. In this embodiment, every two touch wires 310 are spaced apart by four data lines 320. That is, in every twelve sub-pixels, one touch wire 310 is located between G and B, between R and G, or between B and R, and each of the black matrices above the touch wires 310 has a relatively wider width, which can uniformly reduce the light leakage at large viewing angles of the R/G/B solid color screens, thereby improving the color shift at large viewing angles from right perspective and/or left perspective of the R/G/B solid color screens.

According to an embodiment of the invention, the embedded touch liquid crystal display may further include: a liquid crystal layer 370 disposed between the color filter substrate 350 and the transistor substrate 360; an upper polarizer 380 disposed on the color filter (CF) substrate 350; and a lower polarizer 390 is disposed under the transistor (TFT) substrate 360.

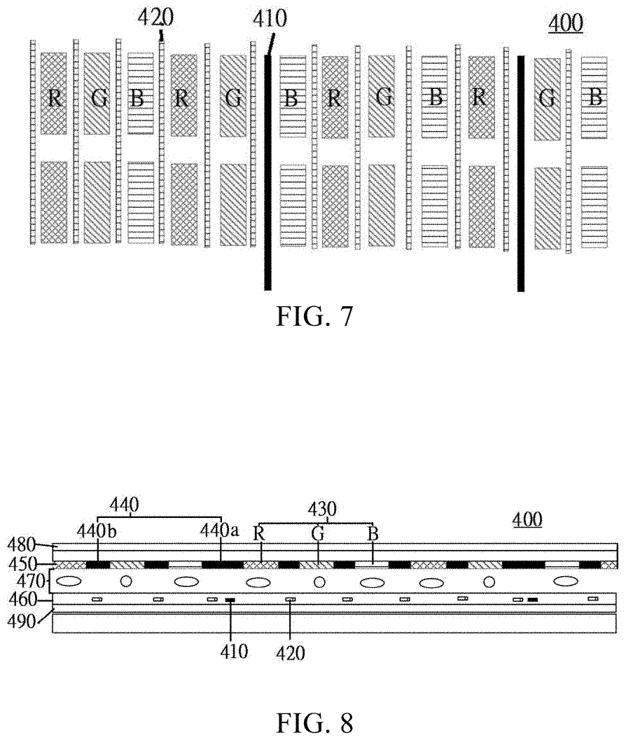

FIG. 7 is a schematic diagram showing an arrangement of sub-pixels, data lines, and touch wires of an embedded touch liquid crystal display according to an embodiment of the invention. FIG. 8 is a side view showing the arrangement of the sub-pixels, the data lines, and the touch wires of the liquid crystal display of FIG. 7. Referring to FIG. 7 and FIG. 8, the present invention provides an embedded touch liquid crystal display 400, including: a color filter (CF) substrate 450 including a plurality of filters 430 and a plurality of black matrices 440 between the plurality of filters 430 arranged in a same layer, wherein the plurality of filters 430 includes at least: a plurality of first filters R′, a plurality of second filters G′, and a plurality of third filters B′, which have colors different from each other, and are sequentially arranged in a first cycle, wherein the first cycle is equal to a number of colors of the filters of the color filter substrate; and a transistor (TFT) substrate 460, disposed under the color filter substrate 450, and including: a plurality of touch wires 410 and a plurality of data lines 420, which are disposed in parallel with each other in a same layer, wherein each of the plurality of touch wires 410 is disposed between adjacent two of the plurality of data lines 420 in a second cycle different from the first cycle.

In the embedded touch liquid crystal display 2400 shown in FIG. 7 and FIG. 8, the plurality of first filters R′, the plurality of second filters G′, and the plurality of third filters a respectively correspond to a plurality of first sub-pixels R, a plurality of second sub-pixels G, and a plurality of third sub-pixels B, which have colors different from each other, and are sequentially arranged in the first cycle.

Still referring to FIG. 7 and FIG. 8, in the this embodiment, the plurality of black matrices 440 include a plurality of first black matrices 440a and a plurality of second black matrices 440b, wherein the plurality of first black matrices 440a correspond to the plurality of touch wires 410 and the data lines 420 adjacent to the plurality of touch wires 410, the plurality of second black matrices 440b correspond to remaining data lines 420, and a width of each of the first black matrices 440a is greater than a width of each of the second black matrices 440b.

In this embodiment, the first cycle is 3, and the plurality of first filters R′, the plurality of second filters G′, and the plurality of third filters B′ are red (R), green (G), and blue (B) respectively. In this embodiment, the second cycle is 5, that is, one touch wire 410 is spaced apart by five data lines 420.

In this embodiment of the present invention, the data lines 420 and the touch wires 410 are arranged in parallel with each other in a same layer, and the touch wires 410 are spaced apart in a certain cycle which is a non-integer multiple of a number of colors of the sub-pixels. By the above arrangement, the plurality of first sub-pixels R, the plurality of second sub-pixels G, and the plurality of third sub-pixels B are uniformly masked by the data lines 420 and the touch wires 410 arranged in parallel with each other in a same layer, and by the corresponding black matrices 440. More specifically, referring to FIG. 7 and FIG. 8, in the above embodiment, a sum of areas of the plurality of first sub-pixels R masked by the corresponding black matrices 440, a sum of areas of the plurality of second sub-pixels G masked by the corresponding black matrices 440, and a sum of areas of the plurality of third sub-pixels B masked by the corresponding black matrices 440 are same. In this embodiment, every two touch wires 410 are spaced apart by five sub-pixels. That is, in every fifty sub-pixels, one touch wire 410 is located between G and B, between R and G, or between B and R, and each of the black matrices above the touch wires 410 has a relatively wider width, which can uniformly reduce the light leakage in large viewing angles of the R/G/B solid color screens, thereby improving the color shift at large viewing angles from right perspective and/or left perspective of the R/G/B solid color screens.

According to an embodiment of the invention, the embedded touch liquid crystal display may further include: a liquid crystal layer 470 disposed between the color filter substrate 450 and the transistor substrate 460; an upper polarizer 480 disposed on the color filter (CF) substrate 450; and a lower polarizer 490 disposed under the transistor (TFT) substrate 460.

The above embodiment is exemplified based on the premise that the embedded touch liquid crystal display includes three types of the sub-pixels R/G/B. However, the embedded touch liquid crystal display of the present invention can be extended to the following scope: the second cycle is M, that is, every two touch wires are spaced apart by M number of sub-pixels, and the touch wires and the data lines are disposed in parallel with each other in a same layer. In addition, each of the black matrices of the color filter corresponding to the touch wires has a relatively wider width. In every N sub-pixels, one touch wire is located between G and B, between R and G, or between B and R, and each of the black matrices above the touch wires has a relatively wider width, which can uniformly reduce the light leakage at large viewing angles of the R/G/B solid color screens, thereby improving the color shift at large viewing angles from right perspective and/or left perspective of the R/G/B solid color screens. A relationship of M and N satisfies N=M*3, and M is not divisible by 3.

Accordingly, although in the above specific embodiment, the second cycle is only exemplified by 2, 4, and 5, it can be understood that the second cycle may be a multiple of any number other than 3, for example, a multiple of 2, a multiple of 5, a multiple of 7, a multiple of 11, a multiple of 13, and so on.

The first cycle in the above embodiments is 3, but the present invention still provides another embodiment, wherein the embedded touch liquid crystal display further includes: a plurality of fourth filters respectively corresponding to a plurality of a fourth sub-pixel, wherein the first cycle is 4, and the plurality of first filters, the plurality of second filters, the plurality of third filters, and the plurality of fourth filters are respectively red (R), green (G), blue (B), and white (W), while the second cycle is not a multiple of 4. For details, please refer to the following embodiments.

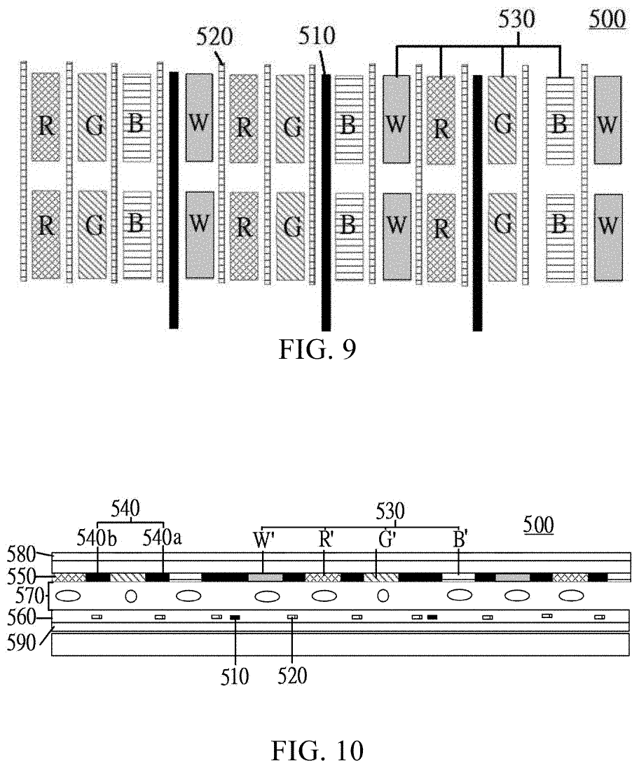

FIG. 9 is a schematic diagram showing an arrangement of sub-pixels, data lines, and touch wires of an embedded touch liquid crystal display according to an embodiment of the invention. FIG. 10 is a side view showing the arrangement of the sub-pixels, the data lines, and the touch wires of the liquid crystal display of FIG. 9. Referring to FIG. 9 and FIG. 10, the present invention provides an embedded touch liquid crystal display 500, including: a color filter (CF) substrate 550 including a plurality of filters 530 and a plurality of black matrices 540 between the plurality of filters 530 arranged in a same layer, wherein the plurality of filters 530 includes at least: a plurality of first filters R′, a plurality of second filters G′, a plurality of third filters B′, and a plurality of fourth filters W′, which have colors different from each other, and are sequentially arranged in a first cycle, wherein the first cycle is equal to a number of colors of the filters of the color filter substrate; and a transistor (TFT) substrate 560, disposed under the color filter substrate 550, and including: a plurality of touch wires 510 and a plurality of data lines 520, which are disposed in parallel with each other in a same layer, wherein each of the plurality of touch wires 510 is disposed between adjacent two of the plurality of data lines 520 in a second cycle different from the first cycle.

In the embedded touch liquid crystal display 500 shown in FIG. 9 and FIG. 10, the plurality of first filters R′, the plurality of second filters G′, the plurality of third filters B′, and the plurality of fourth filters W′ respectively correspond to a plurality of first sub-pixels R, a plurality of second sub-pixels G, and a plurality of third sub-pixels B, and a plurality of fourth sub-pixels W, which have colors different from each other, and are sequentially arranged in the first cycle.

Still referring to FIG. 9 and FIG. 10, in the this embodiment, the plurality of black matrices 2540 include a plurality of first black matrices 540a and a plurality of second black matrices 540b, wherein the plurality of first black matrices 540a correspond to the plurality of touch wires 510 and the data lines 520 adjacent to the plurality of touch wires 510, the plurality of second black matrices 540b correspond to remaining data lines 520, and a width of each of the first black matrices 540a is greater than a width of each of the second black matrices 540b.

In this embodiment, the first cycle is 4, and the plurality of first filters R′, the plurality of second filters G′, the plurality of third filters B′, and the plurality of fourth filters W′ are red (R), green (G), blue (B), and white (W) respectively. In this embodiment, the second cycle is 3, that is, every two touch wires 510 are spaced apart by three data lines 520.

In this embodiment of the present invention, the data lines 520 and the touch wires 510 are arranged in parallel with each other in a same layer, and the touch wires 510 are spaced apart in a certain cycle which is a non-integer multiple of a number of colors of the sub-pixels. By the above arrangement, the plurality of first sub-pixels R, the plurality of second sub-pixels G, the plurality of third sub-pixels B, and the plurality of fourth sub-pixels W are uniformly masked by the data lines 520 and the touch wires 510 arranged in parallel with each other in a same layer, and by the corresponding black matrices 540.

More specifically, referring to FIG. 9 and FIG. 10, in the above embodiment, a sum of areas of the plurality of first sub-pixels R masked by the corresponding black matrices 540, a sum of areas of the plurality of second sub-pixels G masked by the corresponding black matrices 540, a sum of areas of the plurality of third sub-pixels B masked by the corresponding black matrices 440 are same, and a sum of areas of the plurality of fourth sub-pixels W masked by the corresponding black matrices 440 are same.

Similarly, in this embodiment, every two touch wires 510 are spaced apart by three data lines 520. That is, in every twelve sub-pixels, one touch wire 510 is located between G and B, between R and G, between B and W, or between W and R, and each of the black matrices above the touch wires 510 has a relatively wider width, which can uniformly reduce the light leakage at large viewing angles of the R/G/B/W solid color screens, thereby improving the color shift at large viewing angles from right perspective and/or left perspective of the R/G/B/W solid color screens.

The above embodiment is exemplified based on the premise that the embedded touch liquid crystal display includes four types of the sub-pixels R/G/B/W. However, the embedded touch liquid crystal display of the present invention can be extended to the following scope: the second cycle is M, that is, every two touch wires are spaced apart by M number of sub-pixels, and the touch wires and the data lines are disposed in parallel with each other in a same layer. In addition, each of the black matrices of the color filter corresponding to the touch wires has a relatively wider width. In every N of sub-pixels, one touch wire is located between G and B, between R and G, between B and W, or between W and R, and each of the black matrices above the touch wires has a relatively wider width, which can uniformly reduce the light leakage at large viewing angles of the R/G/B solid color screens, thereby improving the color shift at large viewing angles from right perspective and/or left perspective of the R/G/B solid color screens. A relationship of M and N satisfies N=M*4, and M is not divisible by 4.

Accordingly, although in the above specific embodiment, the second cycle is only exemplified by 3, it can be understood that the second cycle may be a multiple of any number other than 4, for example, a multiple of 3, a multiple of 5, a multiple of 6, a multiple of 7, a multiple of 9, a multiple of 10, a multiple of 11, a multiple of 13, and so on.

According to an embodiment of the invention, the embedded touch liquid crystal display may further include: a liquid crystal layer 570 disposed between the color filter substrate 550 and the transistor substrate 560; an upper polarizer 580 disposed on the color filter (CF) substrate 550; and a lower polarizer 590 disposed under the transistor (TFT) substrate 560.

As can be seen from the above listed embodiments, the embedded touch liquid crystal display of the present invention may include a number of X of types of sub-pixels RGB . . . X, and every two touch wires are spaced apart by M number of sub-pixels, wherein the touch wires and the data lines are disposed in parallel with each other in a same layer, and each of the black matrices of the color filter corresponding to the touch wires has a relatively wider width. In every N sub-pixels, one touch wire is disposed between any one of various arrangement and combination of two of the sub-pixels RGB . . . X, and each of the black matrices above the touch wires has a relatively wider width, which can uniformly reduce the light leakage at large viewing angles of the R/G/B solid color screens, thereby improving the color shift at large viewing angles from right perspective and/or left perspective of the R/G/B solid color screens. A relationship of M and N satisfies N=M*X, and M is not divisible by X.

In addition, in some embodiments of the present invention, the embedded touch liquid crystal display may include the touch wires and the dummy touch wires have same structures formed in a same layer by a same process, but are not connected to the touch sensing electrode, to achieve the beneficial effect of avoiding unevenness of the display and reducing the color shift at a large-viewing angle. For example, in an embedded touch liquid crystal display, each row of a touch sensing electrode array includes a plurality of touch sensing electrodes, and the number of touch sensing electrodes is less than the number of touch wires or less than the number of touch wires required. The extra touch wires can be used as the dummy touch wires.

In summary, the present invention provides an embedded touch liquid crystal display for improving color shift at large-viewing angles, in which the data lines and the touch wires are arranged in parallel with each other in a same layer, and the touch wires and/or dummy touch wires are spaced apart in a certain cycle which is a non-integer multiple of a number of colors of the sub-pixels. By the above arrangement, all of the sub-pixels are uniformly masked by the data lines and the touch wires arranged in parallel with each other in a same layer, the touch wires and/or the dummy touch wires, and the black matrices on its opposite side. As such, when a consumer views the embedded touch liquid crystal display of the present invention at a large viewing angle, color shift at a large viewing angle of a screen is improved irrespective of the solid colors being displayed by sub-pixels, thereby obtaining a better display taste.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. An embedded touch liquid crystal display, comprising:
a color filter (CF) substrate comprising a plurality of filters and a plurality of black matrices between the plurality of filters arranged in a same layer, wherein the plurality of filters comprise at least a plurality of first filters, a plurality of second filters, and a plurality of third filters, which have colors different from each other, and are sequentially arranged in a first cycle, wherein the first cycle is equal to a number of colors of the filters of the color filter substrate;
a transistor (TFT) substrate disposed under the color filter substrate and comprising a plurality of touch wires and a plurality of data lines, which are disposed in parallel with each other in a same layer, wherein each of the plurality of touch wires is disposed between adjacent two of the plurality of data lines in a second cycle different from the first cycle, wherein
the plurality of first filters, the plurality of second filters, and the plurality of third filters respectively correspond to a plurality of first sub-pixels, a plurality of second sub-pixels, a plurality of third sub-pixels, which have colors different from each other, and are sequentially arranged in the first cycle, and wherein
the plurality of black matrices comprise a plurality of first black matrices and a plurality of second black matrices, wherein the plurality of first black matrices correspond to the plurality of touch wires and the data lines adjacent to the plurality of touch wires, the plurality of second black matrices correspond to remaining data lines, and a width of each of the first black matrices is greater than a width of each of the second black matrices, and wherein
a sum of areas of the plurality of first sub-pixels masked by the corresponding black matrices, a sum of areas of the plurality of second sub-pixels masked by the corresponding black matrices, and a sum of areas of the plurality of third sub-pixels masked by the corresponding black matrices are same.

2. The embedded touch liquid crystal display of claim 1, wherein the first cycle is 3, and the plurality of first filters, the plurality of second filters, and the plurality of third filters are red (R), green (G), and blue (B) respectively.

3. The embedded touch liquid crystal display of claim 1, wherein the second cycle is not a multiple of 3.

4. The embedded touch liquid crystal display of claim 1, wherein the second cycle is a multiple of 2.

5. The embedded touch liquid crystal display of claim 1, wherein the second cycle is a multiple of 5.

6. The embedded touch liquid crystal display of claim 1, further comprising: a plurality of fourth filters corresponding to a plurality of fourth sub-pixels, wherein the first cycle is 4, and the plurality of first filters, the plurality of second filters, the plurality of third filters, and the plurality of fourth filters are respectively red (R), green (G), blue (B), and white (W), while the second cycle is not a multiple of 4.

7. The embedded touch liquid crystal display of claim 1, further comprising:
a liquid crystal layer disposed between the color filter substrate and the transistor substrate;
an upper polarizer disposed on the color filter (CF) substrate; and
a lower polarizer disposed under the transistor (TFT) substrate.

8. The embedded touch liquid crystal display of claim 1, wherein the embedded touch liquid crystal display is an embedded touch fringe field switch (FFS) liquid crystal display.

9. An embedded touch liquid crystal display, comprising:
a color filter (CF) substrate comprising a plurality of filters and a plurality of black matrices between the plurality of filters arranged in a same layer, wherein the plurality of filters comprises at least: a plurality of first filters, a plurality of second filters, and a plurality of third filters, which have colors different from each other, and are sequentially arranged in a first cycle, wherein the first cycle is equal to a number of colors of the filters of the color filter substrate;
a transistor (TFT) substrate, disposed under the color filter substrate, and comprising: a plurality of touch wires and a plurality of data lines, which are disposed in parallel with each other in a same layer, wherein each of the plurality of touch wires is disposed between adjacent two of the plurality of data lines in a second cycle different from the first cycle, wherein
the plurality of first filters, the plurality of second filters, and the plurality of third filters respectively correspond to a plurality of first sub-pixels, a plurality of second sub-pixels, a plurality of third sub-pixels, which have colors different from each other, and are sequentially arranged in the first cycle.

10. The embedded touch liquid crystal display of claim 9, wherein the plurality of black matrices comprise a plurality of first black matrices and a plurality of second black matrices, wherein the plurality of first black matrices correspond to the plurality of touch wires and the data lines adjacent to the plurality of touch wires, the plurality of second black matrices correspond to remaining data lines, and a width of each of the first black matrices is greater than a width of each of the second black matrices.

11. The embedded touch liquid crystal display according to claim 9, wherein a sum of areas of the plurality of first sub-pixels masked by the corresponding black matrices, a sum of areas of the plurality of second sub-pixels masked by the corresponding black matrices, and a sum of areas of the plurality of third sub-pixels masked by the corresponding black matrices are same.

12. The embedded touch liquid crystal display according to claim 9, wherein the first cycle is 3, and the plurality of first filters, the plurality of second filters, and the plurality of third filters are red (R), green (G), and blue (B) respectively.

13. The embedded touch liquid crystal display of claim 11, wherein the second cycle is not a multiple of 3.

14. The embedded touch liquid crystal display of claim 11, wherein the second cycle is a multiple of 2.

15. The embedded touch liquid crystal display of claim 11, wherein the second cycle is a multiple of 5.

16. The embedded touch liquid crystal display of claim 9, further comprising: a plurality of fourth filters corresponding to a plurality of fourth sub-pixels, wherein the first cycle is 4, and the plurality of first filters, the plurality of second filters, the plurality of third filters, and the plurality of fourth filters are red (R), green (G), blue (B), and white (W), while the second cycle is not a multiple of 4.

17. The embedded touch liquid crystal display of claim 9, further comprising:
a liquid crystal layer disposed between the color filter substrate and the transistor substrate;
an upper polarizer disposed on the color filter (CF) substrate; and
a lower polarizer disposed under the transistor (TFT) substrate.

18. The embedded touch liquid crystal display of claim 9, wherein the embedded touch liquid crystal display is an embedded touch fringe field switch (FFS) liquid crystal display.
